(19) United States
(12) Patent Application Publication
(10) Pub. No.: US 2006/0146074 A1
(43) Pub. Date: Jul. 6, 2006

(54) Display for rotatable steering device

(76) Inventor: Edward R. Harrison, Beaverton, OR (US)

Correspondence Address: INTEL CORPORATION, P.O. BOX 5326, SANTA CLARA, CA, 95056-5326, US

(21) Appl. No.: 11/026,668

(22) Filed: Dec. 31, 2004

(51) Int. Cl. G09G 5/00

(52) U.S. Cl. 345/660

(57) ABSTRACT

A display device can couple to a rotatable steering device and provide an image in a fixed orientation regardless of a rotational position of the rotatable steering device.

### FIELD OF THE INVENTION

The present invention relates to the field of displays. More specifically, the present invention relates to a display for a rotatable steering device.

### BACKGROUND

Automobiles and various other vehicles increasingly use display devices, like those commonly used with personal computers, to present information to drivers. For example, global positioning satellite (GPS) systems in many cars often include a display device mounted near the middle of the dashboard. A GPS display can usually show the location of the car on a map and can provide a user interface to various GPS features. These displays can also be used to present a variety other information and interfaces, such as audio and/or video controls, cabin environment controls, external temperature, fuel economy calculations, vehicle status information including vehicle speed, engine speed, engine temperature, an oil change reminder, tire air pressure, etc.

Since these displays are often located some distance from the driver, they often divert attention away from the road. The level of distraction can be far greater then the buttons, knobs, and dials traditionally used in cars. With knobs and buttons, a driver can often change a radio station or adjust the heater by feel, looking away from the road briefly, if at all. Display devices, on the other hand, often include touch screen capabilities and/or a cursor device to navigate among various menus and modes of operation. A driver may need to look at a display for a comparatively long period of time in order to select an icon or scroll through a menu.

### BRIEF DESCRIPTION OF DRAWINGS

Examples of the present invention are illustrated in the accompanying drawings. The accompanying drawings, however, do not limit the scope of the present invention. Similar references in the drawings indicate similar elements.

FIGS. 1-6 illustrate various embodiments of a display device coupled to a rotatable steering device.

FIG. 7 illustrates a functional block diagram according to one embodiment of the present invention.

FIG. 8 illustrates a method according to one embodiment of the present invention.

FIG. 9 illustrates one embodiment of a method for maintaining a fixed image orientation with a multiple display elements.

FIG. 10 illustrates one embodiment of a method for maintaining a fixed image orientation with a single display element.

FIG. 11 illustrates one embodiment of a hardware system that can perform various functions of the present invention.

FIG. 12 illustrates one embodiment of a machine readable medium to store instructions that can implement various functions of the present invention.

### DETAILED DESCRIPTION OF THE INVENTION

In the following description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternative embodiments. In other instances, well known methods, procedures, components, and circuits have not been described in detail.

Parts of the description will be presented using terminology commonly employed by those skilled in the art to convey the substance of their work to others skilled in the art. Also, parts of the description will be presented in terms of operations performed through the execution of programming instructions. It is well understood by those skilled in the art that these operations often take the form of electrical, magnetic, or optical signals capable of being stored, transferred, combined, and otherwise manipulated through, for instance, electrical components.

Various operations will be described as multiple discrete steps performed in turn in a manner that is helpful for understanding the present invention. However, the order of description should not be construed as to imply that these operations are necessarily performed in the order they are presented, nor even order dependent. Lastly, repeated usage of the phrase “in one embodiment” does not necessarily refer to the same embodiment, although it may.

Embodiments of the present invention can couple a display device to a steering wheel such that an image on the display device remains substantially upright, even as the steering wheel is turned. Embodiments of the present invention can reduce the amount of eye travel from the road to a display in many vehicles by placing the display right in front of the driver. In fact, in many embodiments of the present invention, the display can be so much closer to the driver, and so much easier to read, that considerably smaller displays can be used, even by drivers wearing bifocals.

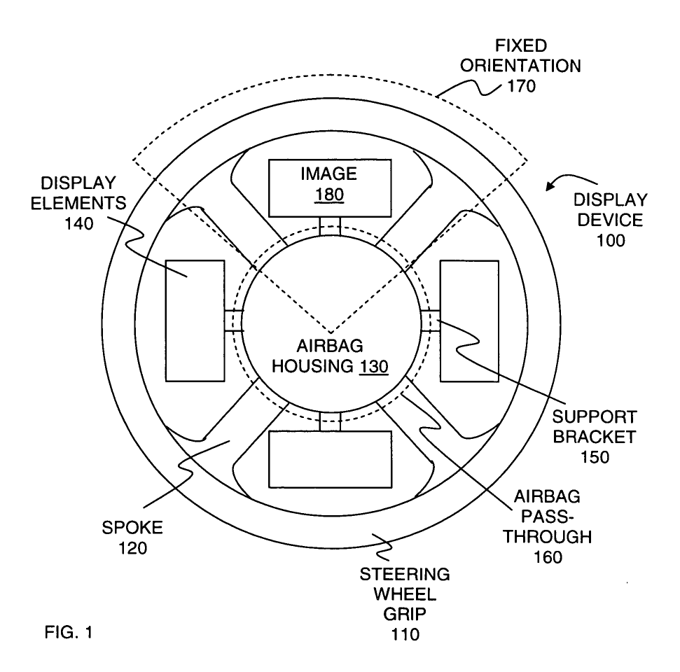

FIG. 1 illustrates an example of a display device 100 that can be mounted to a steering wheel, according to one embodiment of the present invention. In the illustrated example, the steering wheel can include a circular grip 110 and a number of spokes 120 coupled to an airbag housing 130. Display device 100 can include a number of display elements 140. Each display element can be located between a pair of spokes 120. A support bracket 130 can couple each of the display elements to the airbag housing 130.

As the steering wheel is rotated, all of the display elements 140 can rotate with the steering wheel. An image 180 can be provided on one of the display elements 140 that is most upright at any given time. In other words, the image 180 can be maintained within a fixed orientation region 170 by activating and deactivating various ones of the display elements 140 as the steering wheel is turned.

Any number of techniques can be used to determine which mode of operation the display device should be in as the steering wheel turns. For example, with four display elements 140, the fixed orientation region 170 could be a 90 degree quadrant that is fixed with respect to a steering column (not shown) to which the steering wheel is coupled. Each display element 140 could be associated with a particular angular position on the steering wheel, such as zero degrees, 90 degrees, 180 degrees, and 270 degrees. Then, whenever one of the four angular positions on the steering wheel is within the fixed 90 degree quadrant, the associated display element 140 could be activated. Similar approaches could be devised for more or fewer display elements.

Display device 100 can be used in a variety of different ways. For example, display elements 140 can be touch screens. In which case, a driver may be able to operate various controls in image 180 using his or her thumbs, even without removing his or her hands from a safe driving position on grip 110.

In another example, more than one of the display elements 140 may be active at a time. For instance, rather than using region 170 to decide which one of the display devices to activate, region 170 could be used to decide which way to orient an image in one or more of the display elements. That is, if image 180 is oriented so that English text is displayed from left to right in the illustration, then one or more of the other three display elements could also display images oriented so that English text is displayed from left to right. As the steering wheel is turned, the orientation of the image on each active display element can rotate within the respective display element in order to match or approximate the orientation of the image in the fixed region 170.

Since the display elements 140 are rectangular in the illustrated embodiment, an image may also adjust to fit the changing dimensions of a display element as the steering wheel turns. For instance, adjusting to fit the changing dimensions could be similar to switching between portrait and landscape page sizes in a word processing application.

In FIG. 1, by placing the display elements 140 within a periphery of the steering wheel grip 110, the display elements can form an airbag pass-through 160. That is, an airbag can deploy from housing 130 unhindered by the display device.

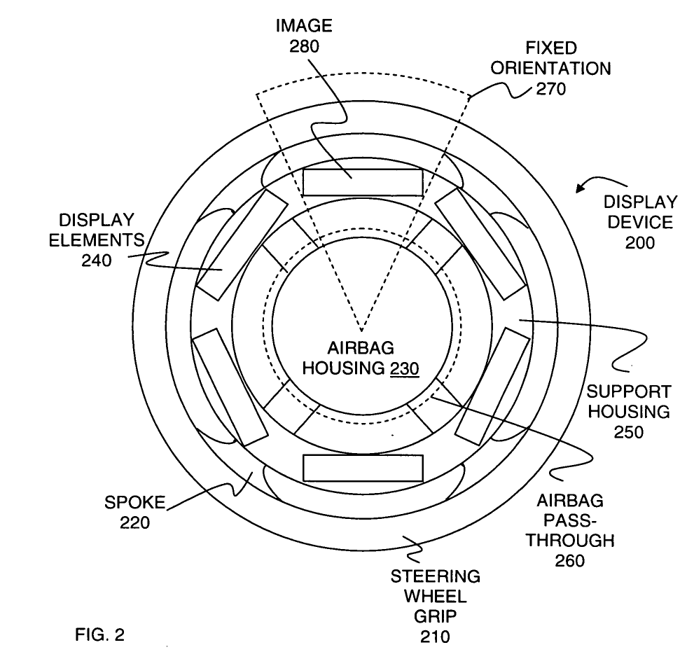

FIG. 2 illustrates an example of a display device 200 that can be mounted to a steering wheel, according to one embodiment of the present invention. As in FIG. 1, the steering wheel can include a grip 210 and a number of spokes 220 coupled to an airbag housing 230. Rather than fitting display elements between the spokes however, display device 200 includes an annular support housing 250, around which a number of display elements 240 can be distributed. The illustrated example shows six display elements 240, although other embodiments may include more or fewer display elements. The annular shape of support housing 250 can form an airbag pass-through 260.

As in FIG. 1, an image 280 can be maintained in a substantially upright orientation within a fixed orientation region 170 by activating and deactivating various ones of the display elements 240 as the steering wheel is turned. In another embodiment, multiple display elements could be activated simultaneously using fixed region 270 to decide which way to orient an image in any active display elements. Each display element 240 could also be a touch screen.

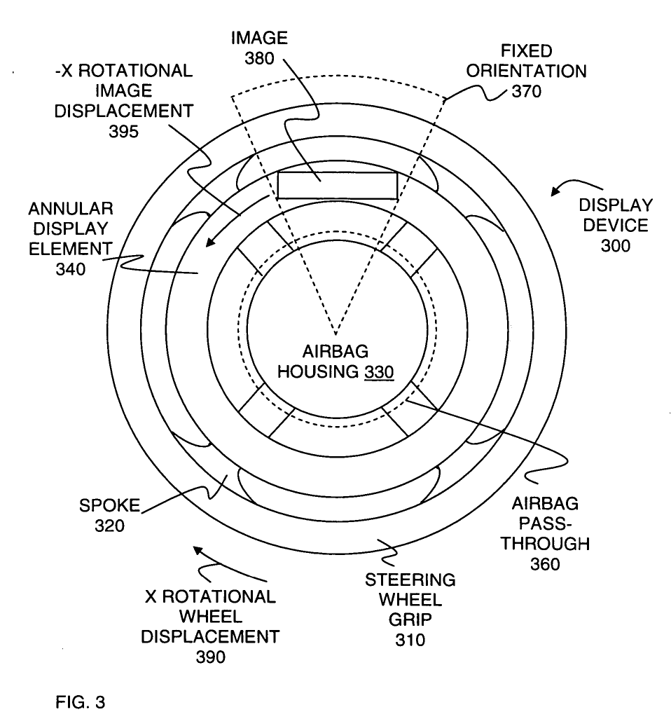

FIG. 3 illustrates an example of a display device 300 that can be mounted to a steering wheel, according to one embodiment of the present invention. As in FIG. 1, the steering wheel can include a grip 310 and a number of spokes 320 coupled to an airbag housing 330. Rather than multiple separate display elements however, display device 300 can include an annular display element 340. Annular display element 340 can include a continuous display surface around the entire annulus so that the image 380 can be displayed continuously as the steering wheel turns. That is, as the steering wheel turns by an X rotational displacement 390, the image 380 can be moved along display element 340 by a −X rotational image displacement 395 to keep the image 380 in the fixed orientation region 370.

As with the embodiments of FIGS. 1 and 2, rather than just displaying an image in fixed region 370, the fixed region 370 could be used to determine the orientation for images at any position around the annular display element 340. Display element 340 could also be a touch screen, and the annular shape can form an airbag pass-through 360.

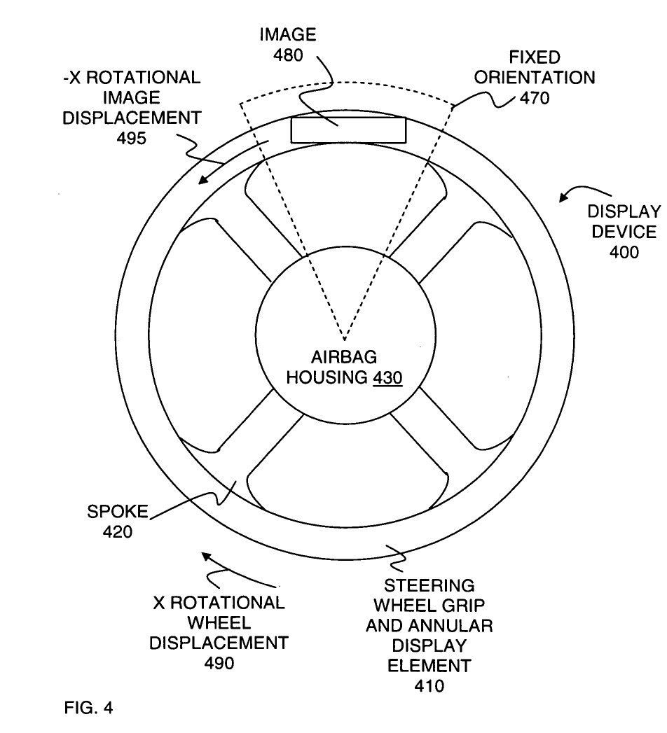

FIG. 4 illustrates an example of a display device 400 that can be mounted to a steering wheel, according to one embodiment of the present invention. As in FIG. 1, the steering wheel can include a grip 410 and a number of spokes 420 coupled to an airbag housing 430. In the illustrated embodiment however, the steering wheel grip can itself include an annular display element that can be used in many of the same ways as the annular display element 340 in FIG. 3. That is, an X rotational wheel displacement 490 can be countered with a −X rotational image displacement 495 to keep the image 480 in the fixed orientation region 470.

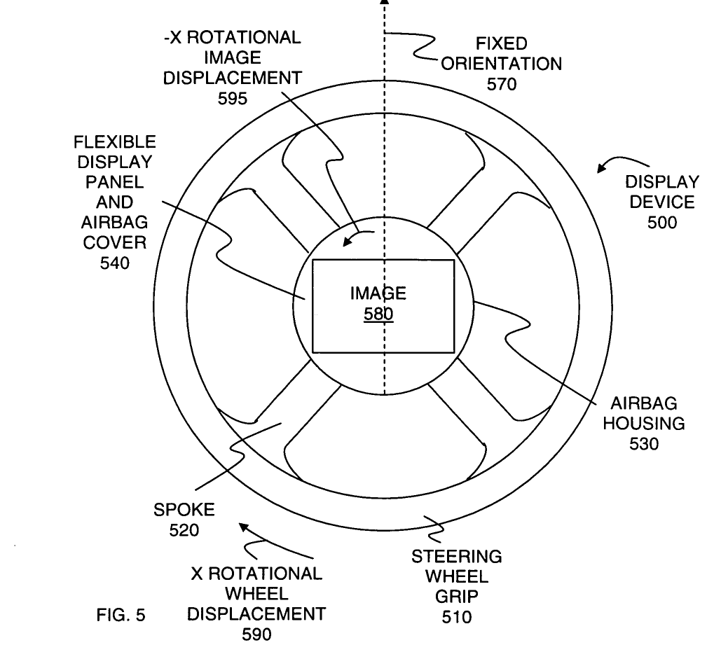

FIG. 5 illustrates an example of a display device 500 that can be mounted to a steering wheel, according to one embodiment of the present invention. As in FIG. 1, the steering wheel can include a grip 510 and a number of spokes 520 coupled to an airbag housing 530. In the illustrated embodiment however, the display panel 540 can be made of a flexible display material so that the display panel itself can form part of the airbag cover. Any of a number of flexible display materials can be used, such as certain light emitting polymers (LEPs). An X rotational wheel displacement 590 can be countered with a −X rotational image displacement 595 to keep the image 580 substantially oriented with respect to the fixed orientation 570.

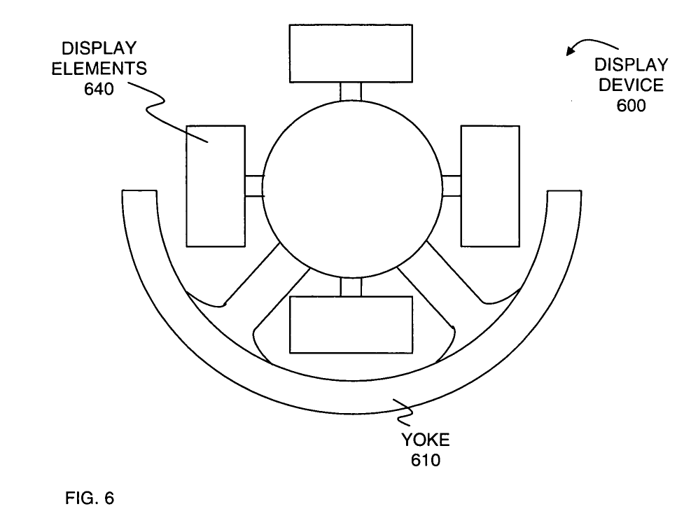

Embodiments of the present invention can be used in virtually any kind of vehicle that has a rotatable steering device, including cars, trucks, tractors, boats, airplanes, submarines, etc. The rotatable steering device can be any of a variety of shapes, sizes, and configurations. For example, FIG. 6 illustrates an example of a display device 600 that can be mounted to a steering yoke 610, as may be found in an airplane, according to one embodiment of the present invention. A number of display elements 640 can be coupled to yoke 610 and operated in many of the same ways as display elements 140 in FIG. 1.

The flexible display material mentioned in the example of FIG. 5 may be desirable for safety reasons in many embodiments of the present invention, includes those described in FIGS. 1-4 and 6.

FIGS. 1-6 illustrate a number of implementation specific details. Other embodiments may not include all the illustrated elements, may arrange the elements differently, may combine one or more of the elements, may include additional elements, and the like. For instance, other embodiments may include more or fewer spokes, more or fewer display elements, display elements of differing sizes and/or shapes, etc. Certain embodiments may include multiple types of displays, such as the annular display element of FIG. 3 with display panel airbag cover of FIG. 5, or the grip display element of FIG. 4 with the separate display elements of FIG. 1, etc. Any number of mechanisms, such as screws, clips, snaps, glue, Velcro, and the like, can be used to couple the display elements to the steering devices.

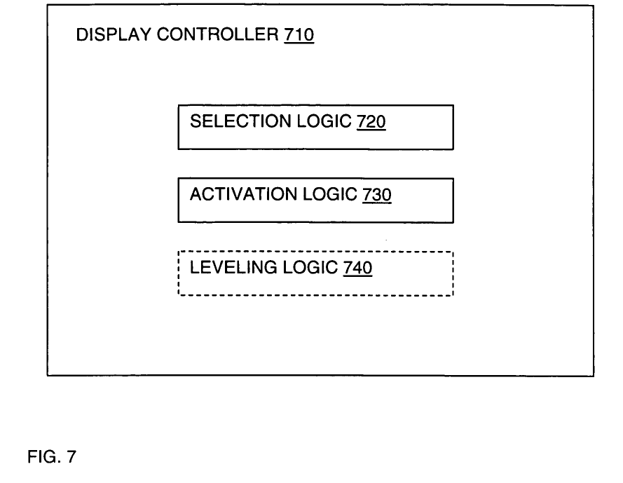

FIG. 7 illustrates a functional block diagram of a display controller 710, according to one embodiment of the present invention. Controller 710 can be used to implement many of the display operations described above. For example, in a display device that includes multiple separate display elements, such as the display devices of FIGS. 1 and 2, controller 710 can include selection logic 720 to identify which display element is most upright with respect to a fixed orientation, and activation logic 730 to activate that display element or to appropriately orient images in multiple display elements. In a display device that includes one display element, such as the display devices of FIGS. 3, 4, and 5, controller 710 can include leveling logic 740 to rotate an image to counteract rotation of the steering device.

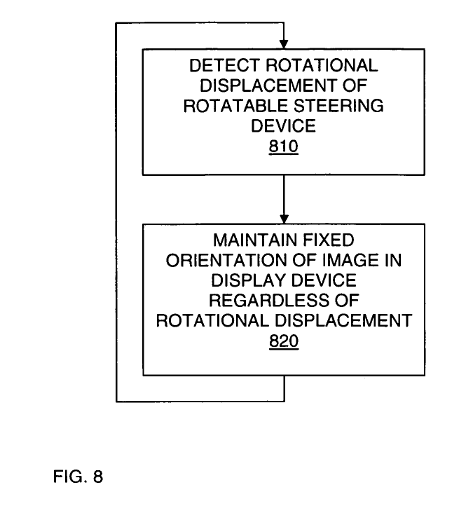

FIG. 8 illustrates a method that could be performed by controller 710, according to one embodiment of the present invention. At 810, the method can detect a rotational displacement of a rotatable steering device. Then, at 820, the method can maintain a fixed orientation of an image in a display device regardless of the rotational displacement. The method can loop continuously. Each time a rotational displacement is detected in 810, the method can maintain the fixed orientation of the image in 820.

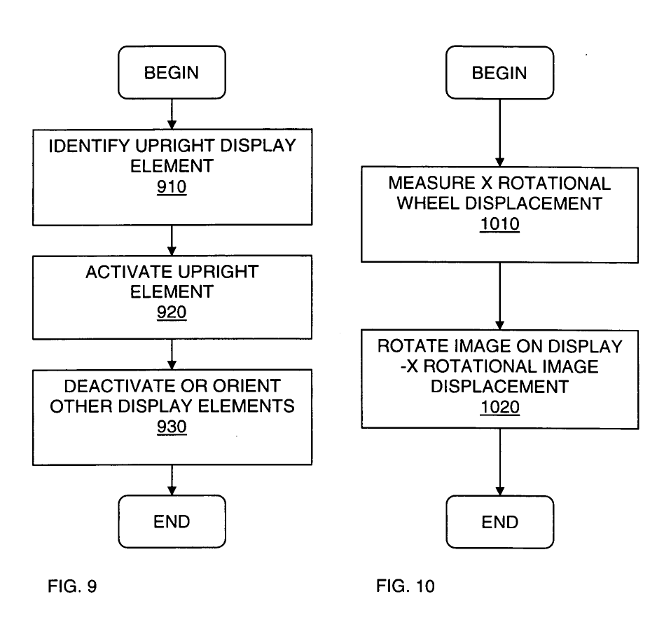

FIG. 9 illustrates a method that could be used for 820 in FIG. 8 to maintain the fixed orientation in a display device with multiple separate display elements. At 910, the method can detect an upright display element among a plurality of display elements. For example, a reference point could be established on a steering device and another reference point could be established on a steering column. Then, different display elements could be associated with certain angular displacements between the two references points. An “upright” element could be identified based on the angular displacement between the two reference points. At 920, the method can activate the upright display element, and, at 930, the method can either deactivate the other display elements or appropriately orient images on the other display elements.

FIG. 10 illustrates a method that could be used for 820 in FIG. 8 to maintain the fixed orientation in a single display element. At 1010, the method can measure an X rotational wheel displacement. For example, this cold be measured using the same two reference points mentioned in the previous paragraph. At 1020, to counter act the rotation, the method can apply a −X rotational image displacement.

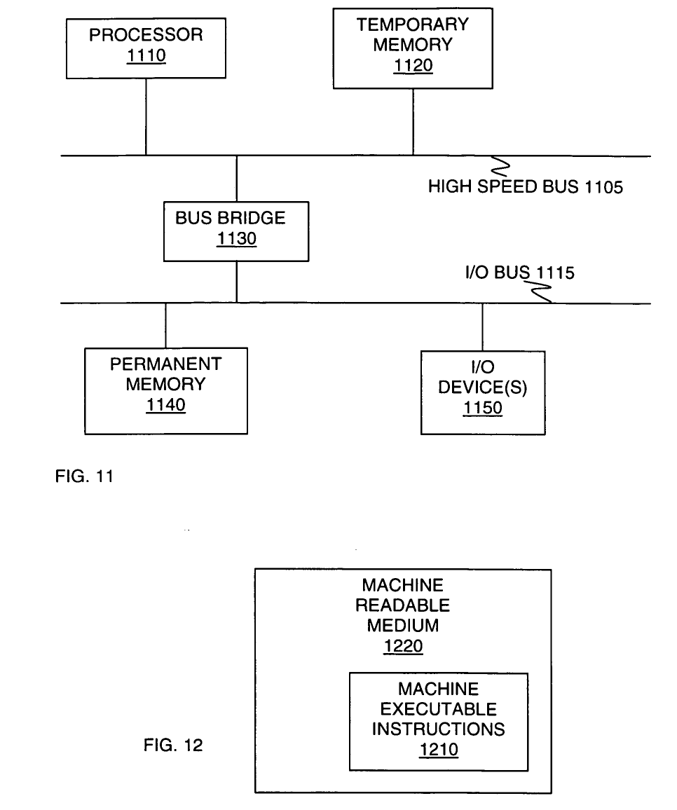

FIG. 11 illustrates one embodiment of a generic hardware system that can bring together the functions of various embodiments of the present invention. In the illustrated embodiment, the hardware system includes processor 1110 coupled to high speed bus 1105, which is coupled to input/output (I/O) bus 1115 through bus bridge 1130. Temporary memory 1120 is coupled to bus 1105. Permanent memory 1140 is coupled to bus 1115. I/O device(s) 1150 is also coupled to bus 1115. I/O device(s) 1150 may include a display device, a keyboard, one or more external network interfaces, etc.

Certain embodiments may include additional components, may not require all of the above components, or may combine one or more components. For instance, temporary memory 1120 may be on-chip with processor 1110. Alternately, permanent memory 1140 may be eliminated and temporary memory 1120 may be replaced with an electrically erasable programmable read only memory (EEPROM), wherein software routines are executed in place from the EEPROM. Some implementations may employ a single bus, to which all of the components are coupled, while other implementations may include one or more additional buses and bus bridges to which various additional components can be coupled. Similarly, a variety of alternate internal networks could be used including, for instance, an internal network based on a high speed system bus with a memory controller hub and an I/O controller hub. Additional components may include additional processors, a CD ROM drive, additional memories, and other peripheral components known in the art.

Various functions of the present invention, as described above, can be implemented using one or more of these hardware systems. In one embodiment, the functions may be implemented as instructions or routines that can be executed by one or more execution units, such as processor 1110, within the hardware system(s). As shown in FIG. 12, these machine executable instructions 1210 can be stored using any machine readable storage medium 1220, including internal memory, such as memories 1120 and 1140 in FIG. 11, as well as various external or remote memories, such as a hard drive, diskette, CD-ROM, magnetic tape, digital video or versatile disk (DVD), laser disk, Flash memory, a server on a network, etc. In one implementation, these software routines can be written in the C programming language. It is to be appreciated, however, that these routines may be implemented in any of a wide variety of programming languages.

In alternate embodiments, various functions of the present invention may be implemented in discrete hardware or firmware. For example, one or more application specific integrated circuits (ASICs) could be programmed with one or more of the above described functions. In another example, one or more functions of the present invention could be implemented in one or more ASICs on additional circuit boards and the circuit boards could be inserted into the computer(s) described above. In another example, one or more programmable gate arrays (PGAs) could be used to implement one or more functions of the present invention. In yet another example, a combination of hardware and software could be used to implement one or more functions of the present invention.

Thus, a display for a rotatable steering device is described. Whereas many alterations and modifications of the present invention will be comprehended by a person skilled in the art after having read the foregoing description, it is to be understood that the particular embodiments shown and described by way of illustration are in no way intended to be considered limiting. Therefore, references to details of particular embodiments are not intended to limit the scope of the claims.

What is claimed is:

1. An apparatus comprising:
a display device; and
a coupling mechanism to couple the display device to a rotatable steering device, said display device to provide an image in a fixed orientation regardless of a rotational position of the rotatable steering device.

2. The apparatus of claim 1 wherein the rotatable steering device is selected from a group comprising a steering wheel and a yoke.

3. The apparatus of claim 1 wherein the display device is to present information selected from a group comprising vehicle speed, remaining fuel capacity, fuel economy, engine temperature, engine oil pressure, audio system controls, video system controls, and a global positioning satellite (GPS) interface.

4. The apparatus of claim 1 wherein the display device comprises:
a plurality of display elements to be distributed over the rotatable steering device at a plurality of orientations with respect to the fixed orientation;
selection logic to identify an up-right display element among the plurality of display elements as the rotatable steering device is rotated, said up-right display element at any given time being within a particular margin of the fixed orientation; and
activation logic to activate a mode of operation for the display device based on the up-right display element.

5. The apparatus of claim 4 wherein the display device further comprises:
an airbag pass-through, said plurality of display elements to couple within a periphery of the rotatable steering device to form the airbag pass-through.

6. The apparatus of claim 1 wherein the display device comprises:
a display panel; and
leveling logic to rotate the image on the display panel in a corresponding opposite direction to a rotation of the rotatable steering device.

7. The apparatus of claim 6 wherein the display panel is selected from a group comprising a flexible airbag cover, an annular display element, and a grip display element.

8. The apparatus of claim 7 wherein the flexible airbag cover comprises a flexible light emitting polymer (LEP).

9. The apparatus of claim 1 wherein the display device comprises a touch screen.

10. A method comprising:
detecting a rotational displacement of a rotatable steering device; and
maintaining a fixed orientation of an image on a display device coupled to the rotatable steering device regardless of the rotational displacement.

11. The method of claim 10 wherein the display device comprises a plurality of display elements distributed over the rotatable steering device at a plurality of orientations with respect to the fixed orientation, and where maintaining the fixed orientation comprises:
identifying an up-right display element among the plurality of display elements as the rotatable steering device is rotated, said up-right display element at any given time being within a particular margin of the fixed orientation; and
activating the up-right display element.

12. The method of claim 11 wherein maintaining the fixed orientation further comprises:
orienting remaining ones of the plurality of display elements based at least in part on the up-right display element.

13. The method of claim 10 wherein the display device comprises a display panel, and wherein maintaining the fixed orientation comprises:
rotating the image on the display panel by a corresponding opposite rotational displacement.

14. A machine readable medium having stored thereon machine executable instructions that, when executed, implement a method comprising:
detecting a rotational displacement of a rotatable steering device; and
maintaining a fixed orientation of an image on a display device coupled to the rotatable steering device regardless of the rotational displacement.

15. The machine readable medium of claim 14 wherein the display device comprises a plurality of display elements distributed over the rotatable steering device at a plurality of orientations with respect to the fixed orientation, and where maintaining the fixed orientation comprises:
identifying an up-right display element among the plurality of display elements as the rotatable steering device is rotated, said up-right display element at any given time being within a particular margin of the fixed orientation; and
activating the up-right display element.

16. The machine readable medium of claim 15 wherein maintaining the fixed orientation further comprises:
orienting remaining ones of the plurality of display elements based at least in part on the up-right display element.

17. The machine readable medium of claim 14 wherein the display device comprises a display panel, and wherein maintaining the fixed orientation comprises:
rotating the image on the display panel by a corresponding opposite rotational displacement.

18. A system comprising:
an automobile;
a rotatable steering device for the automobile; and
a display device to couple to the rotatable steering device, said display device to provide an image in a fixed orientation regardless of a rotational position of the rotatable steering device.

19. The system of claim 18 wherein the display device comprises:
a plurality of display elements to be distributed over the rotatable steering device at a plurality of orientations with respect to the fixed orientation;
selection logic to identify an up-right display element among the plurality of display elements as the rotatable steering device is rotated, said up-right display element at any given time being within a particular margin of the fixed orientation; and
activation logic to activate a mode of operation for the display device based on the up-right display element.

20. The system of claim 18 wherein the display device comprises:
a display panel; and
leveling logic to rotate the image on the display panel in a corresponding opposite direction to a rotation of the rotatable steering device.
